(19) United States
(12) Patent Application Publication
(10) Pub. No.: US 2026/0309167 A1
(43) Pub. Date: Oct. 8, 2026

(54) NOISE REDUCTION AIR INLET BYPASS RECIRCULATION STRUCTURE OF COMPRESSOR

(71) Applicant: HARBIN ENGINEERING UNIVERSITY, Harbin City (CN)

(72) Inventors: Chen LIU, Harbin City (CN); Jiaxuan LIN, Harbin City (CN); Yao SONG, Harbin City (CN); Shaoran DU, Harbin City (CN); Yipeng CAO, Harbin City (CN); Yang LIU, Harbin City (CN); Jie YANG, Harbin City (CN); Xiaochen ZHAO, Harbin City (CN)

(21) Appl. No.: 19/567,708

(22) Filed: Mar. 16, 2026

(30) Foreign Application Priority Data
Apr. 3, 2025 (CN) 202510414596.8

(51) Int. Cl. F04D 29/66; F04D 29/42

(52) U.S. Cl. CPC F04D 29/663; F04D 29/4213

(57) ABSTRACT

A noise reduction gas inlet bypass recirculation structure of a compressor is provided, which specifically relates to the technical field of gas inlet structures of turbochargers. The noise reduction gas inlet bypass recirculation structure includes a gas inlet pipe and a gas inlet bypass recirculation annular sleeve. The gas inlet bypass recirculation annular sleeve is fixedly sleeved over the gas inlet pipe. The gas inlet bypass recirculation annular sleeve includes an inner ring and an outer ring. The outer ring is sleeved over the outer ring. An annular sealed cavity is formed between the inner ring and an outer side wall of the gas inlet pipe. An annular cavity is formed among the outer side wall of the gas inlet pipe, an outer side wall of the inner ring, and an inner side wall of the outer ring.

### CROSS-REFERENCE TO RELATED APPLICATION

This patent application claims the benefit and priority of Chinese Patent Application No. 2025104145968 filed with the China National Intellectual Property Administration on Apr. 3, 2025, the disclosure of which is incorporated by reference herein in its entirety as part of the present application.

### TECHNICAL FIELD

The present disclosure relates to the technical field of gas inlet structures of turbochargers, and in particular, to a noise reduction gas inlet bypass recirculation structure of a compressor.

### BACKGROUND

In recent years, in order to meet requirements for high power performance and high economy indicators of a modern internal combustion engine, especially a requirement put forward by transportation type turbocharged diesel engines and turbocharged diesel engines for construction machinery for maintaining a sufficient supercharge pressure within a wide range of rotating speeds and loads to achieve satisfactory low-speed performance. A matching turbocharger compressor needs to have high efficiency and a wide stable working range, and is especially required to reach a high pressure ratio at a low flow rate. In this way, a surge line of the compressor needs to move in a direction of low flow rate. Using a gas intake bypass recirculation system of the compressor is an effective technical measure to broaden the stable working range of the compressor at the low flow rate, and has been widely applied.

With the advancement of design technology, turbochargers are being constantly developed towards high flow rates and high pressure ratios, and the noise problem of the turbochargers is becoming increasingly prominent. Numerous studies have confirmed that an aerodynamic noise of the compressor has a high sound pressure level frequency and is one of main noise sources of the turbocharger. Therefore, reducing the aerodynamic noise of the compressor can effectively reduce the overall noise of the turbocharger. One of main methods for reducing a noise is to control the noise from a propagation path of the noise. Currently, the noise is reduced commonly by arranging silencers, and there are a few of measures for reducing the noise by changing a structure of a gas inlet pipe of the compressor. The main contribution of the aerodynamic noise of a centrifugal compressor is a discrete single-tone noise, and a frequency of the noise is closely related to a rotating speed of the compressor. In actual operation of a diesel engine, the compressor needs to work at different speeds in different situations. However, in current studies, the structure of the gas inlet pipe of the compressor for reducing noise at different rotating speeds is rarely considered.

### SUMMARY

The present disclosure aims to provide a noise reduction gas inlet bypass recirculation structure of a compressor, so as to solve the problems in the existing art. Noise reduction can be carried out on discrete single tones of the compressor at different rotating speeds, and potential hazards of normal operation of equipment are reduced. It is conductive to normal work and life of workers.

In order to achieve the above objective, the present disclosure provides the following solutions:

The present disclosure provides a noise reduction gas inlet bypass recirculation structure of a compressor, including a gas inlet pipe and a gas inlet bypass recirculation annular sleeve. The gas inlet bypass recirculation annular sleeve is fixedly sleeved over the gas inlet pipe; the gas inlet bypass recirculation annular sleeve includes an inner ring and an outer ring; the outer ring is sleeved with the inner ring; a hollow annular sealed cavity is formed between the inner ring and an outer side wall of the gas inlet pipe; a hollow annular cavity is formed among the outer side wall of the gas inlet pipe, an outer side wall of the inner ring, and an inner side wall of the outer ring; a bypass gas inlet and a bypass gas outlet are formed in a side wall of the gas inlet pipe; both the bypass gas inlet and the bypass gas outlet are communicated to the annular cavity; the inner ring is located between the bypass gas inlet and the bypass gas outlet; the bypass gas inlet is close to a gas outlet of the gas inlet pipe; the bypass gas outlet is close to a gas inlet of the gas inlet pipe; a side wall of an end, away from the gas inlet pipe, of the inner ring is able to elastically deform; and the annular sealed cavity is filled with gas with a certain pressure.

Preferably, the noise reduction gas inlet bypass recirculation structure of the compressor further includes a gas inlet pipe flange; and the gas inlet pipe flange is fixedly connected to one end of the gas outlet of the gas inlet pipe.

Preferably, an axis of the gas inlet pipe, an axis of the inner ring, and an axis of the outer ring are colinear.

Preferably, the gas is nitrogen.

Preferably, the bypass gas inlet and the bypass gas outlet are both circular-ring-shaped openings.

Preferably, an opening width of the bypass gas inlet is identical to an opening width of the bypass gas outlet.

Preferably, a plurality of connection pillars are arranged in a circumferential direction of the bypass gas outlet; and the connection pillars are configured to fixedly connect one end of the gas inlet of the gas inlet pipe to a middle portion of the gas inlet pipe.

Preferably, the plurality of connection pillars are uniformly arranged in a circumferential direction of the gas inlet pipe.

Preferably, the side wall of the end, away from the gas inlet pipe, of the inner ring is an elastic circular-ring thin film.

Preferably, two side walls of the inner ring that are connected to the gas inlet pipe are made of a hard material.

Compared with the prior art, the present disclosure has achieved the following technical effects:

The present disclosure provides a noise reduction gas inlet bypass recirculation structure of the compressor. An aerodynamic noise generated by the compressor can be transmitted into the annular cavity through the bypass gas inlet, and then transmitted out from the bypass gas outlet. At the bypass gas outlet, sound waves from the annular cavity and sound waves from the gas inlet pipe undergo destructive interference. A stroke difference between the two beams of sound waves is continuous within a range, thus achieving a noise reduction effect on a broadband noise including frequencies of discrete single-tone noises. Moreover, a working rotating speed of a centrifugal compressor in a diesel engine varies, so that a frequency of a discrete single-tone noise corresponding to each rotating speed is different, and pressures of a gas flow in the annular cavity are different at different rotating speeds. A gas pressure inside the annular sealed cavity is constant. Therefore, the side wall of the end, away from the gas inlet pipe of the inner ring can undergo different deformations at different rotating speeds, so as to change strokes of sound waves in the annular cavity and achieve a purpose of achieving destructive interference on discrete single-tone noises corresponding to different rotating speeds, thus achieving an effect of reducing the discrete single-tone noises of the compressor at different rotating speeds.

### BRIEF DESCRIPTION OF THE DRAWINGS

To describe the technical solutions in the embodiments of the present disclosure or in the prior art more clearly, the following will briefly introduce the accompanying drawings needing to be used in the embodiments. Apparently, the accompanying drawings in the following description show merely some embodiments of the present disclosure, and a person of ordinary skill in the art may still derive other drawings from the accompanying drawings without creative efforts.

FIG. 1 is a schematic structural diagram of a noise reduction gas inlet bypass recirculation structure of a compressor in a first situation;

FIG. 2 is a diagram of a stroke of a sound wave of a noise reduction gas inlet bypass recirculation structure of a compressor in a first situation;

FIG. 3 is a schematic structural diagram of a noise reduction gas inlet bypass recirculation structure of a compressor in a second situation;

FIG. 4 is a diagram of a stroke of a sound wave of a noise reduction gas inlet bypass recirculation structure of a compressor in a second situation;

FIG. 5 is a schematic structural diagram of a noise reduction gas inlet bypass recirculation structure of a compressor in a third situation; and

FIG. 6 is a diagram of a stroke of a sound wave of a noise reduction gas inlet bypass recirculation structure of a compressor in a third situation.

In the accompanying drawings: 1: gas inlet pipe; 2: outer ring; 3: inner ring; 4: annular sealed cavity; 5: annular cavity; 6: bypass gas inlet; 7: bypass gas outlet; 8: gas inlet of gas inlet pipe; 9: gas outlet of gas inlet pipe; 10: gas inlet pipe flange; and 11: connection pillar.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all the embodiments. All other embodiments obtained by a person of ordinary skill in the art based on the disclosed embodiments without creative efforts shall fall within the protection scope of the present disclosure.

The present disclosure aims to provide a noise reduction gas inlet bypass recirculation structure of a compressor, so as to solve the problems in the existing art. Noises generated by the compressor can be reduced, and potential hazards of normal operation of equipment can be reduced. It is conductive to normal work and life of workers.

In order to make the above objectives, features, and advantages of the present disclosure more comprehensible, the present disclosure will be further described in detail below in combination with the accompanying drawings and specific implementations.

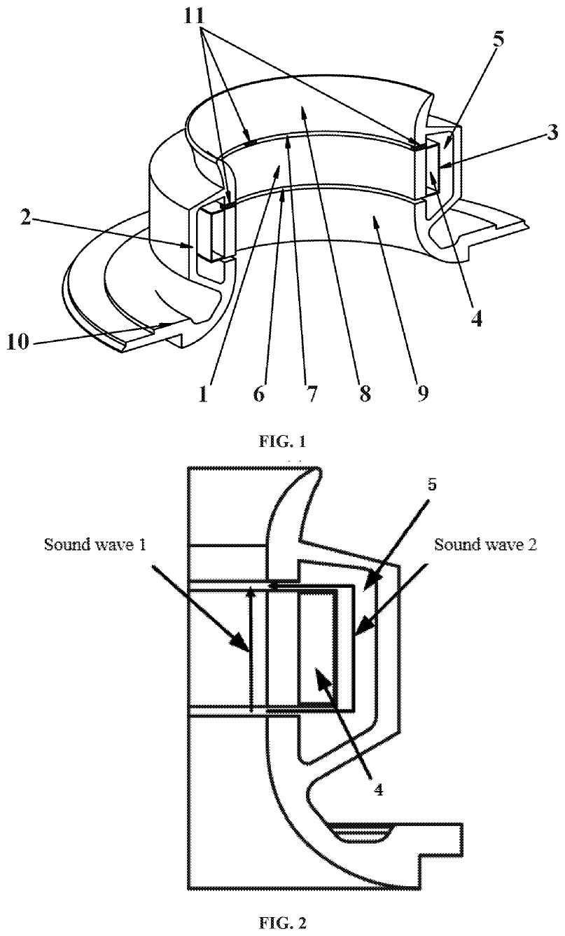

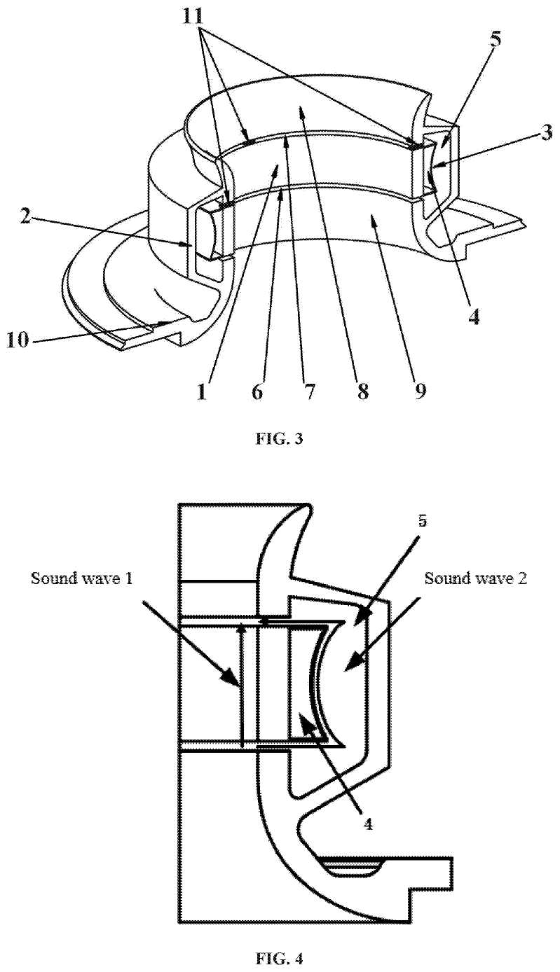

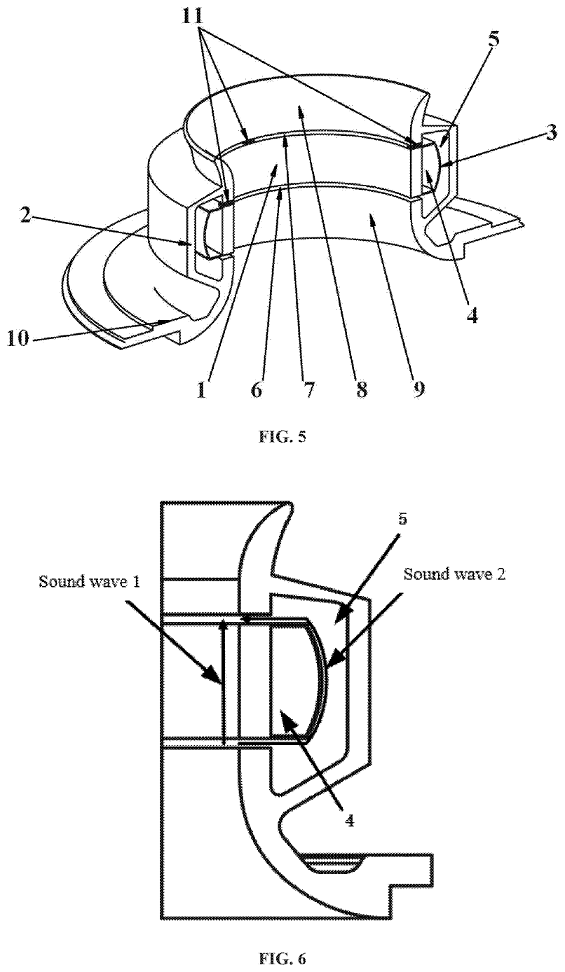

The present disclosure provides a noise reduction gas inlet bypass recirculation structure of a compressor, as shown in FIG. 1 to FIG. 6, including a gas inlet pipe 1 and a gas inlet bypass recirculation annular sleeve. The gas inlet bypass recirculation annular sleeve is fixedly sleeved over the gas inlet pipe 1. The gas inlet bypass recirculation annular sleeve includes an inner ring 3 and an outer ring 2. The outer ring 2 is sleeved with the inner ring 3. A hollow annular sealed cavity 4 is formed between the inner ring 3 and an outer side wall of the gas inlet pipe 1. A hollow annular cavity 5 is formed among the outer side wall of the gas inlet pipe 1, an outer side wall of the inner ring 3, and an inner side wall of the outer ring 2. A bypass gas inlet 6 and a bypass gas outlet 7 are formed in a side wall of the gas inlet pipe 1. Both the bypass gas inlet 6 and the bypass gas outlet 7 are communicated to the annular cavity 5. The inner ring 3 is located between the bypass gas inlet 6 and the bypass gas outlet 7. The bypass gas inlet 6 is close to a gas outlet 9 of the gas inlet pipe. The bypass gas outlet 7 is close to a gas inlet 8 of the gas inlet pipe. A side wall of an end, away from the gas inlet pipe, of the inner ring 3 can elastically deform. The annular sealed cavity 4 is filled with gas with a certain pressure. A high-pressure environment is provided on one side of the gas outlet 9 of the gas inlet pipe, and a low-pressure environment is provided on one side of the gas inlet 8 of the gas inlet pipe. A gas flow flows from the high-pressure side to the low-pressure side. Therefore, the bypass gas inlet 6 is arranged on one side close to the gas outlet 9 of the gas inlet pipe. The gas flow generated by the compressor is transmitted into the annular cavity 5 through the bypass gas inlet 6 and then flows out from the bypass gas outlet 7 after passing through the annular cavity 5. Then, the gas flow flows to an impeller again for turbocharging. At the bypass gas outlet 7, a sound wave from the annular cavity 5 and a sound wave from the gas inlet pipe 1 can undergo destructive interference. A stroke difference between the two beams of sound waves is continuous within a range, thus achieving a noise reduction effect on a broadband noise including frequencies of discrete single-tone noises. Moreover, a working rotating speed of a centrifugal compressor in a diesel engine varies, so that a frequency of a discrete single-tone noise corresponding to each rotating speed is different, and pressures of an air flow in the annular cavity 5 are different at different rotating speeds. A gas pressure inside the annular sealed cavity 4 is constant. Therefore, the side wall of the end, away from the gas inlet pipe of the inner ring 3 can undergo different deformations at different rotating speeds, thus changing a propagation path of a sound wave in the annular cavity 5 to achieve a purpose of achieving destructive interference on discrete single-tone noises corresponding to different rotating speeds and achieve an effect of reducing the discrete single-tone noises of the compressor at different rotating speeds.

Further preferably in the implementation of the present disclosure, the noise reduction gas inlet bypass recirculation structure of the compressor further includes a gas inlet pipe flange 10. The gas inlet pipe flange 10 is fixedly connected to one end of the gas outlet 9 of the gas inlet pipe.

Further preferably in the implementation of the present disclosure, an axis of the gas inlet pipe 1, an axis of the inner ring 3, and an axis of the outer ring 2 are colinear.

Further preferably in the implementation of the present disclosure, the gas is nitrogen or another gas with a pressure and high acoustic impedance. The gas with high acoustic impedance can be used as an effective acoustic barrier.

Further preferably in the implementation of the present disclosure, the bypass gas inlet 6 and the bypass gas outlet 7 are both circular-ring-shaped openings. An opening width of the bypass gas inlet 6 is identical to an opening width of the bypass gas outlet 7.

Further preferably in the implementation of the present disclosure, a plurality of connection pillars 11 are arranged in a circumferential direction of the bypass gas outlet 7. The connection pillars 11 are configured to fixedly connect one end of the gas inlet of the gas inlet pipe to a middle portion of the gas inlet pipe. The plurality of connection pillars 11 are uniformly arranged in a circumferential direction of the gas inlet pipe.

Further preferably in the implementation of the present disclosure, the side wall of the end, away from the gas inlet pipe, of the inner ring 3 is an elastic circular-ring thin film or another elastic element that can under different deformations as a pressure varies. When the rotating speed of the compressor changes, a pressure on an outer side of the circular-ring thin film also changes. The circular-ring thin film can undergo different deformations with the change in the gas pressure within the annular cavity 5, thereby affecting a sound propagation path inside a gas inlet bypass recirculation cavity, so that a variable gas cavity structure can achieve a noise reduction effect at different rotating speeds. Specifically, it can be divided into three typical situations: In a first situation, the gas pressure inside the annular cavity 5 is identical to the pressure inside the annular sealed cavity 4, and the circular-ring thin film does not deform. In a second situation, the gas pressure inside the annular cavity 5 is greater than the pressure inside the annular sealed cavity 4, and the circular-ring thin film undergoes an inward bending deformation. In a third situation, the gas pressure inside the annular cavity 5 is less than the pressure inside the annular sealed cavity 4, and the circular-ring thin film undergoes an outward bending deformation. Strokes of a sound wave 2 within the annular cavity 5 are different in the three situations, while a stroke of a sound wave 1 is constant. Therefore, a stroke difference between the two columns of sound waves at the bypass gas outlet 7 varies as the rotating speed of the compressor changes, so that a suppressed noise frequency band changes as the rotating speed of the compressor changes.

Assuming that the compressor has three rotating speeds: a first rotating speed, a second rotating speed, and a third rotating speed. At the first rotating speed, the variable gas cavity structure corresponds to the first situation. At the second rotating speed, the variable gas cavity structure corresponds to the second situation. At the third rotating speed, the variable gas cavity structure corresponds to the third situation. At the first rotating speed, the frequency of the discrete single-tone noise is λ₁. At the second rotating speed, the frequency of the discrete single-tone noise is λ₂. At the third rotating speed, the frequency of the discrete single-tone noise is λ₃. In the first, second, and third situations, the strokes of the sound wave 2 in the gas inlet bypass recirculation structure cavity are divided into d₂₁, d₂₂, and d₂₃, respectively, and the stroke of the sound wave 1 in the gas inlet pipe is d₁.

$$\vert {d}_{21} - {d}_{1} \vert = ( n + \frac{1}{2} ) {λ}_{1}$$

$$\vert {d}_{22} - {d}_{1} \vert = ( n + \frac{1}{2} ) {λ}_{2}$$

$$\vert {d}_{23} - {d}_{1} \vert = ( n + \frac{1}{2} ) {λ}_{3}$$

Where n is an integer (0, 1, 2, . . . ), a physical meaning of which is to mark the frequency at which destructive interference occurs. Each integer corresponds to a specific stroke difference condition, which determines a frequency band at which sound waves are canceled out in a space. A proper pressure inside the sealed cavity and a proper material of the circular-ring thin film can be obtained through experiments or simulations. As long as the stroke difference between two columns of sound waves at each rotating speed satisfies this formula, the two columns of sound waves can undergo destructive interference, thus achieving the noise reduction effect on the discrete single-tone noises at different rotating speeds. In the present disclosure, a stroke (d₂) of a sound wave within the gas inlet bypass recirculation cavity is changed by changing the rotating speed of the compressor, and the change in the rotating speed causes a change in a wavelength (λ). Ultimately, this formula is continuously satisfied to achieve an adaptive passive noise reduction control effect.

Further preferably in the implementation of the present disclosure, two side walls of the inner ring 3 that are connected to the gas inlet pipe 1 are made of a hard material. When the gas pressure inside the annular cavity 5 changes, the two side walls of the inner ring 3 that are connected to the gas inlet pipe 1 have small deformations.

Specific examples are used in the present disclosure to illustrate the principles and implementations of the present disclosure. The descriptions of the above embodiments are only used to help understand the method of the present disclosure and its core idea; and at the same time, those of ordinary skill in the art will make changes to all the specific implementations and application scopes according to the idea of the present disclosure. In conclusion, the content of this specification shall not be understood as a limitation on the present disclosure.

What is claimed is:

1. A noise reduction gas inlet bypass recirculation structure of a compressor, comprising a gas inlet pipe and a gas inlet bypass recirculation annular sleeve, wherein the gas inlet bypass recirculation annular is fixedly sleeved over the gas inlet pipe; the gas inlet bypass recirculation annular sleeve comprises an inner ring and an outer ring; the outer ring is sleeved over the inner ring; a hollow annular sealed cavity is formed between the inner ring and an outer side wall of the gas inlet pipe; a hollow annular cavity is formed among the outer side wall of the gas inlet pipe, an outer side wall of the inner ring, and an inner side wall of the outer ring; a bypass gas inlet and a bypass gas outlet are formed in a side wall of the gas inlet pipe; both the bypass gas inlet and the bypass gas outlet are communicated to the annular cavity; the inner ring is located between the bypass gas inlet and the bypass gas outlet; the bypass gas inlet is close to a gas outlet of the gas inlet pipe; the bypass gas outlet is close to a gas inlet of the gas inlet pipe; a side wall of an end, away from the gas inlet pipe, of the inner ring is able to elastically deform; and the annular sealed cavity is filled with gas with a certain pressure.

2. The noise reduction gas inlet bypass recirculation structure of the compressor according to claim 1, further comprising a gas inlet pipe flange; and the gas inlet pipe flange is fixedly connected to one end of the gas outlet of the gas inlet pipe.

3. The noise reduction gas inlet bypass recirculation structure of the compressor according to claim 1, wherein an axis of the gas inlet pipe, an axis of the inner ring, and an axis of the outer ring are colinear.

4. The noise reduction gas inlet bypass recirculation structure of the compressor according to claim 1, wherein the gas is nitrogen.

5. The noise reduction gas inlet bypass recirculation structure of the compressor according to claim 1, wherein the bypass gas inlet and the bypass gas outlet are both circular-ring-shaped openings.

6. The noise reduction gas inlet bypass recirculation structure of the compressor according to claim 5, wherein an opening width of the bypass gas inlet is identical to an opening width of the bypass gas outlet.

7. The noise reduction gas inlet bypass recirculation structure of the compressor according to claim 5, wherein a plurality of connection pillars are arranged in a circumferential direction of the bypass gas outlet; and the connection pillars are configured to fixedly connect one end of the gas inlet of the gas inlet pipe to a middle portion of the gas inlet pipe.

8. The noise reduction gas inlet bypass recirculation structure of the compressor according to claim 7, wherein the plurality of connection pillars are uniformly arranged in a circumferential direction of the gas inlet pipe.

9. The noise reduction gas inlet bypass recirculation structure of the compressor according to claim 1, wherein the side wall of the end, away from the gas inlet pipe, of the inner ring is an elastic circular-ring thin film.

10. The noise reduction gas inlet bypass recirculation structure of the compressor according to claim 9, wherein two side walls of the inner ring that are connected to the gas inlet pipe are made of a hard material.
